(19) United States
(12) Patent Application Publication
(10) Pub. No.: US 2025/0091347 A1
(43) Pub. Date: Mar. 20, 2025

(54) IMAGE FORMING APPARATUS

(71) Applicants: Yuta NAKAMURA, Tokyo (JP); Hikaru ISHII, Kanagawa (JP)

(72) Inventors: Yuta NAKAMURA, Tokyo (JP); Hikaru ISHII, Kanagawa (JP)

(21) Appl. No.: 18/824,916

(22) Filed: Sep. 5, 2024

(30) Foreign Application Priority Data
Sep. 15, 2023 (JP) 2023-149994
Jun. 3, 2024 (JP) 2024-090173

(51) Int. Cl. B41J 2/14; B41J 2/21

(52) U.S. Cl. CPC B41J 2/1433; B41J 2/2114

(57) ABSTRACT

An image forming apparatus includes a nozzle plate having two or more nozzle holes along with a piezoelectric element and an ink containing a solvent containing an organic solvent containing an alcohol-based organic solvent with a boiling point not higher than 250 degrees Celsius, wherein the average number of the two or more nozzle holes on the surface of the nozzle plate is 10 holes/mm², and the two or more nozzle holes adjacent to each other along a direction substantially perpendicular to the conveyance direction of a recording medium is spaced 150 to 500 μm apart.

### CROSS-REFERENCE TO RELATED APPLICATIONS

This patent application is based on and claims priority pursuant to 35 U.S.C. § 119 to Japanese Patent Application Nos. 2023-149994 and 2024-090173, filed on Sep. 15, 2023 and Jun. 3, 2024, respectively, in the Japan Patent Office, the entire disclosures of which are hereby incorporated by reference herein.

### BACKGROUND

### Technical Field

The present disclosure relates to an image forming apparatus.

### Description of the Related Art

In recent years, the demand for highly productive printers has been increasing, and faster printing speeds are being achieved by equipping printers with numerous inkjet heads to obtain the necessary resolution.

On the other hand, there is a concern that equipping printers with many inkjet heads increases their size. To address this issue, placing nozzle holes at a high density allows for both miniaturization and increased speed of the printer.

However, conventional technologies have faced the problem of beading occurring when high-speed images are formed with highly dense nozzles.

Additionally, there were issues with insufficient ink wettability in the head liquid chamber, leading to inadequate initial filling performance and discharging stability.

### SUMMARY

According to embodiments of the present invention, an image forming apparatus is provided which includes a nozzle plate having two or more nozzle holes along with a piezoelectric element, and an ink containing a solvent containing an organic solvent containing an alcohol-based organic solvent with a boiling point not higher than 250 degrees Celsius, wherein the average number of the two or more nozzle holes on the surface of the nozzle plate is 10 holes/mm², and the two or more nozzle holes adjacent to each other along a direction substantially perpendicular to the conveyance direction of a recording medium is spaced 150 to 500 μm apart.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a view of an example of the positional relationship between nozzle holes in a nozzle according to an embodiment of the present invention;

FIG. 2 is a perspective explanatory diagram of an image forming apparatus according to an embodiment of the present invention; and

FIG. 3 is a diagram illustrating a perspective explanatory view of the tank in an image forming apparatus according to an embodiment of the present invention.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present invention, an image forming apparatus is provided that achieves good beading quality and excellent dischargeability while images are formed at high speed with highly dense nozzles.

### Image Forming Apparatus

An image forming apparatus according to one embodiment of the present invention includes two or more nozzle holes and a nozzle plate with a piezoelectric element, and ink containing an alcohol-based organic solvent with a boiling point of not higher than 250 degrees Celsius, and may include other optional members.

### Nozzle Plate

The nozzle plate has the nozzle holes and a piezoelectric element.

An image forming apparatus according to one embodiment of the present invention can discharge ink from the nozzle holes formed on the surface of the nozzle plate by vibrating the piezoelectric element formed on the nozzle plate.

The nozzle holes are formed on the surface of the nozzle plate (hereinafter also referred to as the “ink discharging surface”), with at least two or more being formed. The average number of the two or more nozzle holes on a surface of the nozzle plate is 10 holes/mm² and the distance between adjacent nozzle holes in a direction substantially perpendicular to the conveyance direction of the recording medium is spaced 150 to 500 μm apart.

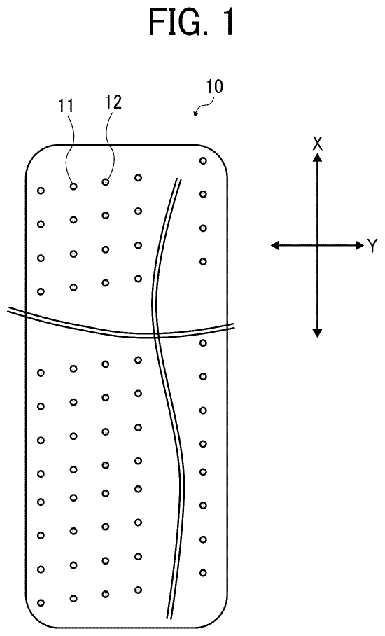

FIG. 1 is a diagram illustrating a view of an example of the positional relationship between the nozzle holes in a nozzle according to an embodiment of the present invention. As illustrated in FIG. 1, the nozzle 10 has multiple nozzle holes (such as 11 and 12 in FIG. 1). The direction substantially perpendicular to the conveyance direction of the recording medium refers not only to the perfectly vertical direction Y relative to the conveyance direction X of the recording medium illustrated in FIG. 1 but also to directions where the nozzle holes, such as nozzle hole 11 and nozzle hole 12, are adjacent in an oblique direction relative to the vertical direction Y.

The ink for use in the image forming apparatus according to one embodiment of the present invention is described below.

The ink contains an ink containing a solvent containing an organic solvent containing an alcohol-based organic solvent and may optionally furthermore contain other components such as water, coloring materials, resins, and additives.

### Organic Solvent

In one embodiment of the present invention, an alcohol-based organic solvent with a boiling point of not higher than 250 degrees Celsius at atmospheric pressure is used as the organic solvent.

There are no particular restrictions on the alcohol-based organic solvent, and it can be suitably selected to suit to a particular application. Examples include, but are not limited to, polyhydric alcohols, polyhydric alcohol alkyl ethers, and polyhydric alcohol aryl ethers. The alcohol-based organic solvent is not particularly limited and can be suitably selected to suit to a particular application.

Specific examples of the alcohol-based organic solvent include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether and ethylene glycol monobenzylether.

Among these, glycol ethers with a boiling point not higher than 180 degrees Celsius are preferred not only because they function as humectants and solubilizers but also because they provide good drying properties.

Polyol compounds having eight or more carbon atoms and glycol ether compounds are also suitable.

Specific examples of the polyol compounds containing 8 or more carbon atoms include, but are not limited to, 2-ethyl-1,3-hexanediol and 2,2,4-trimethyl-1,3-pentanediol.

Specific examples of the glycolether compounds include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

A polyol compound having eight or more carbon atoms and a glycol ether compound enhance permeability of ink for paper used as a recording medium.

The proportion of the organic solvent in the ink has no particular limit and can be suitably selected to suit to a particular application.

The proportion in the total content of the ink is preferably from 5 to 60 percent by mass and more preferably from 20 to 60 percent by mass to enhance drying property and discharging reliability of the ink. Moreover, when the aforementioned organic solvent is a glycol ether compound, it is preferable for the content of the glycol ether compound in the ink to be between 5 percent by mass and 10 percent by mass.

The boiling point of the alcohol-based organic solvent is preferably not higher than 250 degrees Celsius, and more preferably not higher than 180 degrees Celsius. When the boiling point is not higher than 250 degrees Celsius, the occurrence of beading attributable to a high-density nozzle head can be prevented.

### Water

The proportion of water in the ink is not particularly limited and can be suitably selected to suit to a particular application. It is preferably from 10 to 90 percent by mass and more preferably from 20 to 60 percent by mass to quickly dry the ink and stably discharge it.

### Coloring Material

The coloring material has no specific limit and is suitably selected to suit to a particular application. For example, pigments and dyes are usable.

As the pigment. an inorganic pigment or organic pigment is included. These can be used alone or in combination. Mixed crystal can also be used as the coloring material.

Examples of the pigments include, but are not limited to, black pigments, yellow pigments, magenta pigments, cyan pigments, white pigments, green pigments, orange pigments, and gloss or metallic pigments of gold, silver, and others.

Carbon black available from known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments with high affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 to 15 percent by mass and more preferably from 1 to 10 percent by mass to enhance the image density, fixability, and discharging stability.

Pigment dispersion ink is obtained by, for example, preparing a self-dispersible pigment by introducing a hydrophilic functional group into a pigment, coating the surface of a pigment with a resin followed by dispersion, or using a dispersant for dispersing a pigment.

One such method of preparing a self-dispersible pigment by introducing a hydrophilic functional group into a pigment is to add a functional group such as a sulfone group and carboxyl group to a pigment (e.g., carbon) to disperse the pigment in water.

One such method of dispersing a pigment by coating the surface of the pigment with resin is to encapsulate pigment particles in microcapsules for dispersion in water. This microencapsulated pigment is also referred to as a resin-coated pigment. The resin-coated pigment particles in ink are not necessarily entirely coated with resin.

Pigment particles not partially or wholly covered with resin may be dispersed in ink unless such particles have an adverse impact.

One such method of using a dispersant for dispersing a pigment is to use a known dispersant of a small or large molecular weight, typically a surfactant.

It is possible to use surfactants such as an anionic surfactant, a cationic surfactant, a nonionic surfactant, and an amphoteric surfactant depending on a pigment.

Also, a nonionic surfactant, RT-100, available from TAKEMOTO OIL & FAT CO., LTD. and a formalin condensate of naphthalene sodium sulfonate are suitable as the dispersant. Those can be used alone or in combination.

### Pigment Dispersion

The ink can be obtained by mixing a pigment with materials such as water and an organic solvent. It is also possible to mix a pigment with water, a dispersant, and other substances to prepare a pigment dispersion and thereafter mix the pigment dispersion with materials such as water and an organic solvent to manufacture an ink.

The particle size of this pigment dispersion is adjusted by mixing or dispersing with water, a pigment, a pigment dispersant, and other optional components. It is good to use a dispersing device for dispersion.

The particle diameter of the pigment in the pigment dispersion has no particular limit. For example, the maximum frequency is preferably from 20 to 500 nm and more preferably from 20 to 150 nm in the maximum number conversion to improve dispersion stability of the pigment and ameliorate discharging stability and the image quality such as image density. The particle diameter of a pigment can be analyzed using a particle size analyzer (Nanotrac Wave-UT151, available from MicrotracBEL Corp).

The proportion of the pigment in the pigment dispersion is not particularly limited and can be suitably selected to suit a particular application. It is preferably from 0.1 to 50 percent by mass and more preferably from 0.1 to 30 percent by mass to enhance the discharging stability and image density.

It is preferable that the pigment dispersion be filtered with an instrument such as filter and a centrifuge to remove coarse particles followed by deaerating.

### Resin

The type of the resin contained in ink has no particular limit and can be suitably selected to suit to a particular application. It includes, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins. Resin particles made of such resins can be also used. It is possible to obtain an ink by mixing a resin emulsion in which such resin particles are dispersed in water as a dispersion medium with materials such as a coloring material and an organic solvent.

The resin particle can be synthesized or procured.

These resins can be used alone or two or more types of the resin particles.

The volume average particle diameter (mean volume diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve good fixability and image density.

The volume average particle diameter can be measured by using a device such as a particle size analyzer (Nanotrac Wave-UT151, available from MicrotracBEL Corp.).

The proportion of the resin is not particularly limited and can be suitably selected to suit to a particular application. It is preferably from 1 to 30 percent by mass and more preferably from 5 to 20 percent by mass to an entire ink to ensure fixability and storage stability of the ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as optical density. The solid content includes particles such as resin particles and pigment particles. The particle diameter can be measured by using a particle size analyzer (Nanotrac Wave-UT151, available from by MicrotracBEL Corp).

### Additive

The ink may further optionally include additives such as a surfactant, defoaming agent, preservative and fungicide, corrosion inhibitor, and pH regulator.

### Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. Of these, the surfactants not decomposable in a high pH environment are preferable. Examples include, but are not limited to, side chain modified polydimethyl siloxane, both terminal-modified polydimethyl siloxane, one-terminal-modified polydimethyl siloxane, and side-chain-both-terminal-modified polydimethyl siloxane. Silicone-based surfactants having a polyoxyethylene group or a polyoxyethylene polyoxypropylene group as a modification group are particularly preferable because such an aqueous surfactant demonstrates good properties. The silicone-based surfactant includes a polyether-modified silicone-based surfactant, one of which is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂ (CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates. These can be used alone or in combination.

The silicone-based surfactant has no particular limitation and can be suitably selected to suit to a particular application. Specific examples include, but are not limited to, side-chain-modified polydimethyl siloxane, both end-modified polydimethyl siloxane, one-end-modified polydimethyl siloxane, and side-chain-both-end-modified polydimethyl siloxane. A polyether-modified silicone-based surfactant having a polyoxyethylene group or a polyoxyethylene polyoxypropylene group is particularly preferable because such a surfactant demonstrates good property as an aqueous surfactant.

Such surfactants can be synthesized or commercially procured. Products can be procured from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

The polyether-modified silicon-based surfactant is not particularly limited and it can be suitably selected to suit to a particular application. One such surfactant is a compound in which the polyalkylene oxide structure represented by the following Chemical Formula S-1 is introduced into the side chain of the Si site of dimethyl polysiloxane.

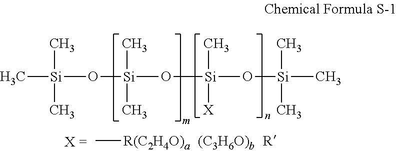

In Chemical Formula S-1, “m”, “n”, “a”, and “b” each, respectively independently represent integers, R represents an alkylene group, and R′ represents an alkyl group.

The polyether-modified silicone-based surfactants can be procured.

Specific examples include, but are not limited to, KF-618, KF-642, and KF-643 (all available from Shin-Etsu Chemical Co., Ltd.), EMALEX-SS-5602 and SS-1906EX (both available from NIHON EMULSION Co., Ltd.), FZ-2105, FZ-2118, FZ-2154, FZ-2161, FZ-2162, FZ-2163, and FZ-2164 (all available from Dow Corning Toray Co., Ltd.), BYK-33 and BYK-387 (both available from BYK-Chemie GmbH), and TSF4440, TSF4452, and TSF4453 (all available from Momentive Performance Materials Inc.).

A fluorochemical surfactant in which the number of carbon atoms replaced with fluorine atoms is 2 to 16 is preferable and, 4 to 16, more preferable.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain.

Of these, polyoxyalkylene ether polymer compounds having a perfluoroalkyl ether group in its side chain are preferable because these do not readily foam and the fluorochemical surfactant represented by the following Chemical Formula F-1 or Chemical Formula F-2 is preferable.

CF₃CF₂(CF₂CF)ₘ—CH₂CH₂O(CH₂CH₂O)ₙH Chemical Formula F-1

In the Chemical Formula F-1, “m” is preferably 0 or an integer of from 1 to 10 and “n” is preferably 0 or an integer of from 1 to 40.

CₙF₂ₙ₊₁—CH₂CH(OH)CH₂—O—(CH₂CH₂O)ₐ—Y Chemical Formula F-2

In the compound represented by Chemical Formula F-2, Y represents H or CₙF₂ₙ₊₁, where n represents an integer of from 1 to 6 or CH₂CH(OH) CH₂—CₙF₂ₙ₊₁, where n represents an integer of from 4 to 6, or CₚH₂ₚ₊₁, where p is an integer of from 1 to 19. a represents an integer of from 4 to 14.

The fluorochemical surfactant can be procured.

Specific examples include, but are not limited to, SURFLON S-111, S-112, S-113, S-121, S-131, S-132, S-141, and S-145 (all available from ASAHI GLASS CO., LTD.); FLUORAD FC-93, FC-95, FC-98, FC-129, FC-135, FC-170C, FC-430, and FC-431 (all available from SUMITOMO 3M); MEGAFACE F-470, F-1405, and F-474 (all available from DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all available from The Chemours Company); FT-110, FT-250, FT-251, FT-400S, FT-150, and FT-400SW (all available from NEOS COMPANY LIMITED); POLYFOX PF-136A, PF-156A, PF-151N, PF-154, and PF-159 (available from OMNOVA SOLUTIONS INC.); and UNIDYNE™ DSN-403N (available from DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (available from DAIKIN INDUSTRIES, Ltd.) are particularly preferable.

The proportion of the surfactant in an ink is not particularly limited and it can be suitably selected to suit a particular application. It is preferably from 0.001 to 5 percent by mass and more preferably from 0.05 percent by mass to 5 percent by mass to achieve good wettability and discharging stability and enhance the image quality.

There are no particular restrictions on the HLB value of the aforementioned surfactant, and it can be suitably selected to suit to a particular application. A value of 8 or less is preferable, and a value of 4 or less is more preferable.

The HLB value is defined by the following formula (Griffin method) and is an indicator showing the balance between the hydrophilic and lipophilic groups of the surfactant.

HLB value=20×(sum of the molecular weight of the hydrophilic portion/molecular weight) Formula (Griffin method)

The HLB value ranges from 0 to 20, with values closer to 0 indicating higher lipophilicity and values closer to 20 indicating higher hydrophilicity.

The silicone-based surfactant satisfying the HLB value can be procured.

Specific example include, but are not limited to, Silface SAG005 (HLB value: 7.0) and Silface SAG008 (HLB value: 7.0), both are available from Nisshin Chemical Co., Ltd., FZ2110 (HLB value: 1.0, FZ2166 (HLB value: 5.8), SH-3772M (HLB value: 6.0), L7001 (HLB value: 7.4), SH-3773M (HLB value: 8.0), all of which are available from Dow Corning Toray Co., Ltd.), KF-945 (HLB value: 4.0), and KF-6017 (HLB value: 4.5), both of which are available from Shin-Etsu Chemical Co., Ltd., and FormBan MS-575 (HLB value: 5.0), available from Ultra Additives Inc.).

### Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

### Preservatives and Fungicides

The preservatives and fungicides are not particularly limited. A specific example is 1,2-benzisothiazoline-3-one.

### pH Regulator

The pH regulator is not particularly limited as long as it can control the pH to 7 or greater. It includes, but is not limited to, amines such as diethanol amine and triethanol amine.

Properties of the ink are not particularly limited and they can be suitably selected to suit to a particular application. The ink preferably has properties, such as viscosity, surface tension, and pH, in the following ranges.

The ink preferably has a viscosity of from 5 to 30 mPa's and more preferably from 5 to 25 mPa·s at 25 degrees C. to enhance the print density and text quality and achieve good dischargeability. Viscosity can be measured with equipment such as a rotatory viscometer, RE-80L, available from TOKI SANGYO CO., LTD. The measuring conditions are as follows:
Standard cone rotor (1° 34′×R24)
Sample liquid amount: 1.2 mL
Rate of rotation: 50 rotations per minute (rpm)
25 degrees C.
Measuring time: three minutes.

The surface tension of ink is preferably 35 mN/m or less and more preferably 32 mN/m or less at 25 degrees C. because the ink suitably levels on a recording medium and the ink dries in a short time.

pH of the ink is preferably from 7 to 12 and more preferably from 8 to 11 to prevent corrosion of the metal material in contact with liquid.

### Recording (Printing) Medium

The recording medium is not particularly limited. Materials such as plain paper, gloss paper, special paper, and cloth are usable. Also, good images can be formed on a non-permeating substrate.

The non-permeating substrate has a surface with low moisture permeability and absorbency. It includes a material having a number of hollow spaces inside that are not open to the outside. To be more quantitative, the substrate has a water-absorbency of 10 or less mL/m² between the start of the contact and 30 msec^{1/2} after the start according to Bristow's method.

Specific examples of the non-permeable substrate include, but are not limited to plastic films such as polyvinyl chloride resin, polyethylene terephthalate (PET), polypropylene, polyethylene, and polycarbonate film.

The polypropylene and polyethylene mentioned above are not particularly limited. Specific examples include, but are not limited to, AR1025, AR1056, AR1082, EC1082, 1082D, 1073D, 1056D, 1025D, and FR1073 (all available from DuPont-Asahi Flash Spun Products Co., Ltd.), P2002, P2102, P2108, P2161, P2171, P2111, P4266, P5767, P3162, P6181, P8121, P1162, P1111, P1128, P1181, P1153, P1157, P1146, P1147, and P1171 (all available from TOYOBO CO., LTD.), YPI, Aqua-Yupo, SUPERYUPO®, ULTRAYUPO®, New YUPO®, YUPO® Electronic Appliance's Warranty, YUPO® building material paper, YUPO® High-Gloss, YUPOJET®, and Metallized YUPO (all available from Yupo Corporation).

### Recorded (Printed) Matter

The ink recorded matter includes a recording medium and an image formed on the recording medium with the ink

The recorded matter is obtained by an inkjet recording device executing an inkjet recording method.

### Recording (Printing) Device and Recording (Printing) Method

The ink can be suitably applied to a recording (printing) device employing inkjet printing, such as a printer, facsimile machine, photocopier, multifunction peripheral (serving as a printer, a facsimile machine, and a photocopier), and solid freeform fabrication device such as a 3D printer and additive manufacturing device.

In the present application, the recording (printing) device and the recording (printing) method respectively represent a device capable of discharging ink and various processing fluids to a recording (printing) medium and a method of conducting recording (printing) on the medium utilizing the device. The recording (printing) medium refers to an item to which ink or processing fluids can be temporarily or permanently attached.

The recording (printing) device may furthermore optionally include a device relating to feeding, conveying, and ejecting a printing medium and other devices referred to as a pre-processing device and a post-processing device in addition to the head portion for discharging an ink.

The printing device and the printing method may further optionally include a heater for use in the heating process and a drier for use in the drying process. For example, the heating device and the drying device include devices including heating and drying the print surface of a printing medium and the opposite surface thereof. The heating device and the drying device are not particularly limited. For example, a fan heater and an infra-red heater can be used. Heating and drying can be conducted before, in the middle of, or after printing. When an infrared heater is used, at least a near infrared irradiator is provided.

As the near-infrared irradiation device, a device is known including a halogen lamp and a reflection mirror. A near-infrared irradiation device is commercialized in which a halogen heater is incorporated into a reflection mirror to form a heating unit for efficient heating.

Specific examples include, but are not limited to, UH—USC-CL300, UHUSC-CL700, UH—USC-CL1000, UH-US-CL300, UHUSD-CL700, UH-USD-CL1000, UH-MA1-CL300, UHMA1-CL700, and UH-MA1-CL1000 (all available from USHIO INC.).

In addition, the printing device and the printing method are not limited to those producing meaningful visible images such as text and figures with ink. Devices for creating patterns like geometric design and 3D images are included. In addition, the printing device includes both a serial type device with a movable liquid discharging head and a line type device with a fixed liquid discharging head, unless otherwise specified.

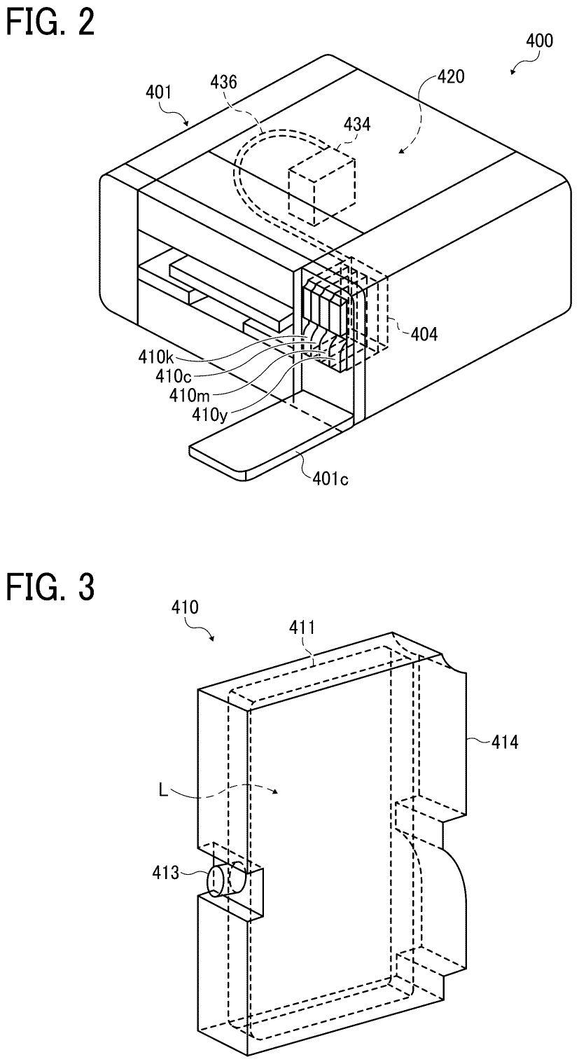

Furthermore, in addition to the desktop type, this printing device includes a device capable of printing images on a wide printing medium having, for example, A0 size, and a continuous printer capable of using continuous paper rolled up in a roll-like form as a printing medium. The recording (printing) device is described using an example with reference to FIG. 2 and FIG. 3. FIG. 2 is a diagram illustrating a perspective view of the same device. FIG. 3 is a diagram illustrating a perspective view of a tank.

An image forming apparatus 400 as an embodiment of the printing device is a serial image forming apparatus. The image forming apparatus 400 includes a mechanical unit 420 inside an exterior 401. Each ink accommodating unit (ink container) 411 of each tank 410 (410k, 410c, 410m, and 410y) for each color of black (K), cyan (C), magenta (M), and yellow (Y) is made of a packaging member such as aluminum laminate film. The ink accommodating unit 411 is housed in, for example, a plastic container housing unit 414 and L represents liquid contained in the ink accommodating unit 411. The tank 410 is used as an ink cartridge of each color.

A cartridge holder 404 is disposed on the rear side of the opening appearing when a cover 401c is opened. The tank 410 is detachably attached to the cartridge holder 404. This configuration enables each ink discharging outlet 413 of the tank 410 to communicate with a discharging head 434 for each color via a supplying tube 436 for each color so that the ink can be discharged from the discharging head 434 to a printing medium.

This printing device may include not only a portion for discharging ink but also a device referred to as a pre-processing device and a post-processing device.

As an example of the pre-processing device and the post-processing device, like the ink of black (K), cyan (C), magenta (M), and yellow (Y) ink, the pre-processing device and the post-processing device may further include a liquid accommodating unit including a pre-processing liquid or a post-processing liquid and a liquid discharging head to discharge the pre-processing liquid or the post-processing liquid according to an inkjet printing method.

As another example of the pre-processing device and the post-processing device, it is suitable to dispose a pre-processing device and a post-processing device not employing the inkjet printing method but a blade coating method, a roll coating method, or a spray coating method.

Notably, the ink is applicable not only to the inkjet printing but can be widely applied in other methods.

Specific examples of such methods other than inkjetting include, but are not limited to, blade coating methods, gravure coating methods, bar coating methods, roll coating methods, dip coating methods, curtain coating methods, slide coating methods, die coating methods, and spray coating methods.

Terms such as image forming, recording, printing, and print used in the present disclosure represent the same meaning.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples and Comparative Examples but are not limited thereto.

In Examples, parts means parts by mass and percent means percent by mass excluding those in the evaluation criteria.

### Preparation Example of Pigment Dispersion

### Preparation of Black Pigment Dispersion

After preliminarily mixing the following materials of black pigment dispersion, the mixture was subjected to circulation dispersion for seven hours with a disk type bead mill (KDL type, media: zirconia ball having a diameter of 0.3 mm, available from SHINMARU ENTERPRISES CORPORATION) to obtain a black pigment dispersion (concentration of pigment solid portion: 20 percent by mass) of self dispersion type.

### Materials of Black Pigment Dispersion

Carbon black pigment (Product: Monarch 800, available from Cabot Corporation): 20 parts
Anionic surfactant (Pionine A-51-B, available from TAKEMOTO OIL & FAT Co., Ltd.): 2 parts
Deionized water: 78 parts

### Preparation Example 1 of Ink

The ink materials shown below were mixed, stirred, and filtered through a 5 μm filter (Minisart by Sartorius) to obtain the ink of Example 1.

### Ink Material

Black pigment dispersion mentioned above: 15 parts by mass
Polyurethane resin: SUPERFLEX 300 (available from DKS Co. Ltd., solid content concentration of 30 percent by mass): 23.3 parts by mass
KF-945 (siloxane-based surfactant, HLB: 4.0, available from Shin-Etsu Chemical Co., Ltd.): 2 parts by mass
1,2-propane diol (boiling point of 187 degrees Celsius): 15 parts by mass
2-ethyl-1,6-hexane diol (boiling point of 243 degrees Celsius): 5 parts by mass
Diethylene glycol diethylether (boiling point of 188 degrees C., glycolether): 5 parts by mass
3-methoxy-3-methylbutanol (boiling point of 174 degrees Celsius): 5 parts by mass
PROXEL LV (asepticus, available from Avecia): 0.1 parts by mass
Deionized water: 29.6 parts by mass

### Preparation Examples 2 to 21 of Ink

Inks 2 to 21 were prepared in the same manner as for Ink 1 according to the prescriptions shown in Tables 1 to 4.

TABLE 1

| | | Example | Example | Example | Example | Example | Example |
|---|---|---|---|---|---|---|---|
| | | 1 | 2 | 3 | 4 | 5 | 6 |
| Ink No. | | 1 | 2 | 3 | 4 | 5 | 6 |
| Coloring | Black | 15 | 15 | 15 | 15 | 15 | 15 |
| material | pigment | | | | | | |
| | dispersion | | | | | | |
| | (solid mass) | | | | | | |
| | with non- | | | | | | |
| | volatile | | | | | | |
| | component of | | | | | | |
| | 20 percent | | | | | | |
| Resin | Polyurethane | 23.3 | 23.3 | 23.3 | 23.3 | 13.3 | 36.7 |
| | resin | | | | | | |
| | Super flex | | | | | | |
| | 300 | | | | | | |
| | (polyurethane | | | | | | |
| | resin solids | | | | | | |
| | content | | | | | | |
| | concentration: | | | | | | |
| | 30 percent by | | | | | | |
| | mass) | | | | | | |
| | Styrene | — | — | — | — | — | — |
| | acrylic resin | | | | | | |
| | J-450 (resin | | | | | | |
| | solids content | | | | | | |
| | concentration: | | | | | | |
| | 42 percent by | | | | | | |
| | mass) | | | | | | |
| Surfactant | KF-945 | 2 | 2 | 2 | 2 | 2 | 2 |
| | (HLB: 4.0) | | | | | | |
| | KF-6017 | — | — | — | — | — | — |
| | (HLB: 4.5) | | | | | | |
| | SH-3773M | — | — | — | — | — | — |
| | (HLB: 8.0) | | | | | | |
| Organic | 1,2- | 15 | 15 | 20 | 7 | 15 | 15 |
| solvent | propanediol, | | | | | | |
| | boiling point | | | | | | |
| | of 187 | | | | | | |
| | degrees | | | | | | |
| | Celsius, | | | | | | |
| | surface | | | | | | |
| | tension of | | | | | | |
| | 38.6 mN/m) | | | | | | |
| | 1,3-propane | — | — | — | — | — | — |
| | diol (boiling | | | | | | |
| | point of 214 | | | | | | |
| | degrees | | | | | | |
| | Celsius, | | | | | | |
| | surface | | | | | | |
| | tension of | | | | | | |
| | 46.8 mN/m) | | | | | | |
| | 2-ethyl-1,6- | 5 | 5 | 5 | 5 | 5 | 5 |
| | hexane diol | | | | | | |
| | (boiling point | | | | | | |
| | of 243 | | | | | | |
| | degrees | | | | | | |
| | Celsius, | | | | | | |
| | surface | | | | | | |
| | tension of | | | | | | |
| | 29.8 mN/m) | | | | | | |
| | Glycerin | — | — | — | — | — | — |
| | (boiling point | | | | | | |
| | of 290 | | | | | | |
| | degrees C., | | | | | | |
| | surface | | | | | | |
| | tension of | | | | | | |
| | 63.4 mN/m) | | | | | | |
| | Diethylene | 5 | 5 | — | — | 5 | 5 |
| | glycol | | | | | | |
| | diethylether | | | | | | |
| | (boiling point | | | | | | |
| | of 188 | | | | | | |
| | degrees | | | | | | |
| | Celsius, | | | | | | |
| | surface | | | | | | |
| | tension of | | | | | | |
| | 25.0 mN/m)) | | | | | | |
| | 3-methoxy- | — | 5 | 5 | 13 | — | — |
| | N,N-dimethyl | | | | | | |
| | propionamide | | | | | | |
| | (boiling point | | | | | | |
| | of 216 | | | | | | |
| | degrees C., | | | | | | |
| | surface | | | | | | |
| | tension of | | | | | | |
| | 34.9 mN/m) | | | | | | |
| | 2-Pyrrolidone | — | — | — | — | — | — |
| | (boiling point | | | | | | |
| | of 246 | | | | | | |
| | degrees C., | | | | | | |
| | surface | | | | | | |
| | tension of | | | | | | |
| | 46.0 mN/m) | | | | | | |
| | 3-methoxy-3- | 5 | — | — | — | 5 | 5 |
| | methylbutanol | | | | | | |
| | (boiling point | | | | | | |
| | of 174 | | | | | | |
| | degrees | | | | | | |
| | Celsius, | | | | | | |
| | surface | | | | | | |
| | tension of | | | | | | |
| | 29.9 mN/m) | | | | | | |
| Additive | PROXEL LV | 0.1 | 0.1 | 0.1 | 0.1 | 0.1 | 0.1 |
| | Deionized | Balance | Balance | Balance | Balance | Balance | Balance |
| | water | | | | | | |

| | | | | | | |
|---|---|---|---|---|---|---|
| Total amount | 100 | 100 | 100 | 100 | 100 | 100 |

TABLE 2

| | | Example | Example | Example | Example | Example | Example |
|---|---|---|---|---|---|---|---|
| | | 7 | 8 | 9 | 10 | 11 | 12 |
| Ink No. | | 7 | 8 | 9 | 10 | 11 | 12 |
| Coloring | Black pigment | 15 | 15 | 15 | 15 | 15.0 | 15.0 |
| material | dispersion | | | | | | |
| | with | | | | | | |
| | non-volatile | | | | | | |
| | portion of 20 | | | | | | |
| | percent | | | | | | |
| Resin | Polyurethane | — | 23.3 | 23.3 | 23.3 | 23.3 | 23.3 |
| | resin | | | | | | |
| | Super flex 300 | | | | | | |
| | (solids content | | | | | | |
| | concentration: | | | | | | |
| | 30 percent by | | | | | | |
| | mass) | | | | | | |
| | Styrene | 16.7 | — | — | — | — | — |
| | acrylic resin J- | | | | | | |
| | 450 (resin | | | | | | |
| | solids content | | | | | | |
| | concentration: | | | | | | |
| | 42 percent by | | | | | | |
| | mass) | | | | | | |
| Surfactant | KF-945 | 2 | 2 | — | — | 2 | 2 |
| | (HLB: 4.0) | | | | | | |
| | KF-6017 | — | — | 2 | — | — | — |
| | (HLB: 4.5) | | | | | | |
| | SH-3773M | — | — | — | 2 | — | — |
| | (HLB: 8.0) | | | | | | |
| Organic | 1,2-propane | 15 | 15 | 15 | 15 | 15 | 15 |
| solvent | diol (boiling | | | | | | |
| | point of 187 | | | | | | |
| | degrees | | | | | | |
| | Celsius, | | | | | | |
| | surface | | | | | | |
| | tension of | | | | | | |
| | 38.6 mN/m) | | | | | | |
| | 1,3-propane | — | 10 | — | — | — | — |
| | diol (boiling | | | | | | |
| | point of 214 | | | | | | |
| | degrees | | | | | | |
| | Celsius, | | | | | | |
| | surface | | | | | | |
| | tension of | | | | | | |
| | 46.8 mN/m) | | | | | | |
| | 2-ethyl-1,6- | 5 | — | 5 | 5 | 5 | 5 |
| | hexane diol | | | | | | |
| | (boiling point | | | | | | |
| | of 243 degrees | | | | | | |
| | Celsius, | | | | | | |
| | surface | | | | | | |
| | tension of | | | | | | |
| | 29.8 mN/m) | | | | | | |
| | Glycerin | — | — | — | — | — | — |
| | (boiling point: | | | | | | |
| | 290 degrees | | | | | | |
| | Celsius, | | | | | | |
| | surface | | | | | | |
| | tension of | | | | | | |
| | 63.4 mN/m) | | | | | | |
| | Diethylene | 5 | — | 5 | 5 | 3 | 8 |
| | glycol | | | | | | |
| | diethylether | | | | | | |
| | (boiling point | | | | | | |
| | of 188 degrees | | | | | | |
| | Celsius, | | | | | | |
| | surface | | | | | | |
| | tension of | | | | | | |
| | 25.0 mN/m) | | | | | | |
| | 3-methoxy- | — | 5 | — | — | 5 | 5 |
| | N,N-dimethyl | | | | | | |
| | propionamide | | | | | | |
| | (boiling point: | | | | | | |
| | 216 degrees | | | | | | |
| | Celsius, | | | | | | |
| | surface | | | | | | |
| | tension of | | | | | | |
| | 34.9 mN/m) | | | | | | |
| | 2-Pyrrolidone | — | — | — | — | — | — |
| | (boiling point | | | | | | |
| | of 246 degrees | | | | | | |
| | C., surface | | | | | | |
| | tension of | | | | | | |
| | 46.0 mN/m) | | | | | | |
| | 3-methoxy-3- | 5 | — | 5 | 5 | 3 | — |
| | methylbutanol | | | | | | |
| | (boiling point | | | | | | |
| | of 174 degrees | | | | | | |
| | Celsius, | | | | | | |
| | surface | | | | | | |
| | tension of | | | | | | |
| | 29.9 mN/m) | | | | | | |
| Additive | PROXEL LV | 0.1 | 0.1 | 0.1 | 0.1 | 0.1 | 0.1 |
| | Deionized | Balance | Balance | Balance | Balance | Balance | Balance |
| | water | | | | | | |

| | | | | | | |
|---|---|---|---|---|---|---|
| Total amount | 100 | 100 | 100 | 100 | 100 | 100 |

TABLE 3

| | | Comparative | Comparative |
|---|---|---|---|
| | | Example 1 | Example 2 |
| Ink No. | | 13 | 14 |
| Coloring | Black pigment dispersion with | 15.0 | 15.0 |
| material | non-volatile portion of 20 percent | | |
| Resin | Polyurethane resin | 23.3 | 23.3 |
| | Super flex 300 (solids content | | |
| | concentration: 30 percent by mass) | | |
| | Styrene acrylic resin J-450 (resin | — | — |
| | solids content concentration: 42 | | |
| | percent by mass) | | |
| Surfactant | KF-945 (HLB: 4.0) | 2 | 2 |
| | KF-6017 (HLB: 4.5) | — | — |
| | SH-3773M (HLB: 8.0) | — | — |
| Organic | 1,2-propane diol (boiling point of | — | — |
| solvent | 187 degrees Celsius, surface tension | | |
| | of 38.6 mN/m) | | |
| | 1,3-propane diol (boiling point of | — | — |
| | 214 degrees Celsius, surface tension | | |
| | of 46.8 mN/m) | | |
| | 2-ethyl-1,6-hexane diol (boiling | — | — |
| | point of 243 degrees Celsius, | | |
| | surface tension of 29.8 mN/m) | | |
| | Glycerin (boiling point of 290 | 20.0 | — |
| | degrees C., surface tension of 63.4 | | |
| | mN/m) | | |
| | Diethylene glycol diethylether | — | — |
| | (boiling point of 188 degrees | | |
| | Celsius, surface tension of 25.0 | | |
| | mN/m) | | |
| | 3-methoxy-N,N-dimethyl | 5.0 | 20.0 |
| | propionamide (boiling point: 216 | | |
| | degrees Celsius, surface tension of | | |
| | 34.9 mN/m) | | |
| | 2-Pyrrolidone (boiling point of 246 | 5.0 | 5.0 |
| | degrees C., surface tension of 46.0 | | |
| | mN/m) | | |
| | 3-methoxy-3-methylbutanol (boiling | — | — |
| | point of 174 degrees Celsius, | | |
| | surface tension of 29.9 mN/m) | | |
| Additive | PROXEL LV | 0.1 | 0.1 |
| | Deionized water | Balance | Balance |

| | | |
|---|---|---|
| Total amount | 100 | 100 |

TABLE 4

| | | Example | Example | Example | Example |
|---|---|---|---|---|---|
| | | 13 | 14 | 15 | 16 |
| Ink No. | | 15 | 16 | 17 | 18 |
| Coloring | Black pigment dispersion with | 15 | 15 | 15 | 15 |
| material | non-volatile portion of 20 | | | | |
| | percent | | | | |
| Resin | Polyurethane resin | 23.3 | 23.3 | 23.3 | 23.3 |
| | Super flex 300 (solids content | | | | |
| | concentration: 30 percent by | | | | |
| | mass) | | | | |
| | Styrene acrylic resin J-450 | — | — | — | — |
| | (resin solids content | | | | |
| | concentration: 42 percent by | | | | |
| | mass) | | | | |
| Surfactant | KF-945 (HLB: 4.0) | 2 | 2 | 2 | 2 |
| | KF-6017 (HLB: 4.5) | — | — | — | — |
| | SH-3773M (HLB: 8.0) | — | — | — | — |
| Organic | 1,2-propanediol, boiling point | 15 | 15 | 15 | 15 |
| solvent | of 187 degrees Celsius, surface | | | | |
| | tension of 38.6 mN/m) | | | | |
| | 1,3-propane diol (boiling point | — | — | — | — |
| | of 214 degrees Celsius, surface | | | | |
| | tension of 46.8 mN/m) | | | | |
| | 2-ethyl-1,6-hexane diol (boiling | 5 | 5 | 5 | 5 |
| | point of 243 degrees Celsius, | | | | |
| | surface tension of 29.8 mN/m) | | | | |
| | Glycerin (boiling point of 290 | — | — | — | — |
| | degrees C., surface tension of | | | | |
| | 63.4 mN/m) | | | | |
| | Diethylene glycol diethylether | — | 2 | 3 | — |
| | (boiling point of 188 degrees | | | | |
| | Celsius, surface tension of 25.0 | | | | |
| | mN/m) | | | | |
| | 3-methoxy-N,N-dimethyl | 5 | 5 | 5 | 5 |
| | propionamide (boiling point: | | | | |
| | 216 degrees Celsius, surface | | | | |
| | tension of 34.9 mN/m) | | | | |
| | 2-Pyrrolidone (boiling point of | — | — | — | — |
| | 246 degrees C., surface tension | | | | |
| | of 46.0 mN/m) | | | | |
| | 3-methoxy-3-methylbutanol | 8 | 2 | — | 3 |
| | (boiling point of 174 degrees | | | | |
| | Celsius, surface tension of 29.9 | | | | |
| | mN/m) | | | | |
| Additive | PROXEL LV | 0.1 | 0.1 | 0.1 | 0.1 |
| | Deionized water | Balance | Balance | Balance | Balance |

| | | | | |
|---|---|---|---|---|
| Total amount | 100 | 100 | 100 | 100 |

| | | Example | Example | Example |
|---|---|---|---|---|
| | | 17 | 18 | 19 |
| Ink No. | | 19 | 20 | 21 |
| Coloring | Black pigment dispersion with | 15 | 15 | 15 |
| material | non-volatile portion of 20 percent | | | |
| Resin | Polyurethane resin | 23.3 | 23.3 | 23.3 |
| | Super flex 300 (solids content | | | |
| | concentration: 30 percent by mass) | | | |
| | Styrene acrylic resin J-450 (resin | — | — | — |
| | solids content concentration: 42 | | | |
| | percent by mass) | | | |
| Surfactant | KF-945 (HLB: 4.0) | 2 | 2 | 2 |
| | KF-6017 (HLB: 4.5) | — | — | — |
| | SH-3773M (HLB: 8.0) | — | — | — |
| Organic | 1,2-propanediol, boiling point of | 15 | 15 | 15 |
| solvent | 187 degrees Celsius, surface tension | | | |
| | of 38.6 mN/m) | | | |
| | 1,3-propane diol (boiling point of | — | — | — |
| | 214 degrees Celsius, surface tension | | | |
| | of 46.8 mN/m) | | | |
| | 2-ethyl-1,6-hexane diol (boiling | 5 | 5 | 5 |
| | point of 243 degrees Celsius, | | | |
| | surface tension of 29.8 mN/m) | | | |
| | Glycerin (boiling point of 290 | — | — | — |
| | degrees C., surface tension of 63.4 | | | |
| | mN/m) | | | |
| | Diethylene glycol diethylether | 6 | 11 | — |
| | (boiling point of 188 degrees | | | |
| | Celsius, surface tension of 25.0 | | | |
| | mN/m) | | | |
| | 3-methoxy-N,N-dimethyl | — | — | — |
| | propionamide (boiling point: 216 | | | |
| | degrees Celsius, surface tension of | | | |
| | 34.9 mN/m) | | | |
| | 2-Pyrrolidone (boiling point of 246 | — | — | — |
| | degrees C., surface tension of 46.0 | | | |
| | mN/m) | | | |
| | 3-methoxy-3-methylbutanol (boiling | 6 | — | 11 |
| | point of 174 degrees Celsius, | | | |
| | surface tension of 29.9 mN/m) | | | |
| Additive | PROXEL LV | 0.1 | 0.1 | 0.1 |
| | Deionized water | Balance | Balance | Balance |

| | | | |
|---|---|---|---|
| Total amount | 100 | 100 | 100 |

In addition, the details of the materials in Tables 1 to 4 are as follows.

### Resin

J-450 (styrene acrylic resin particle, non-volatile: 42 percent by mass, available from Johnson Polymer)

### Surfactant

KF-6017: siloxane-based surfactant, available from Shin-Etsu Chemical Co., Ltd.
SH-3773M: siloxane-based surfactant, available from Dow Corning Toray Co., Ltd.

### Examples 1 to 19 and Comparative Examples 1 to 2

In Examples 1 to 19 and Comparative Examples 1 and 2, inks 1 to 21, as shown in Tables 1 to 4, were each loaded into a modified version of the IPSiO GXe5000 inkjet printer (available from Ricoh Co., Ltd.) to form an image forming apparatus. Solid images were printed with these image forming apparatuses at a resolution of 600 dpi on OK Top Coat+ (available from Oji Paper Co., Ltd.) as the printing medium.

The modified IPSiO GXe5500 printer has at least two or more nozzle holes and a nozzle plate with piezoelectric elements. The number of nozzle holes on the surface of the nozzle plate is an average of 20 holes/mm², and the distance between adjacent nozzle holes in the direction approximately perpendicular to the conveyance direction of the printing medium is 250 μm. The head is replaced with a high-density nozzle head to allow for high-density image formation.

The image forming apparatuses in Examples 1 to 19 and Comparative Examples 1 and 2 were evaluated for “drying property,” “discharge stability,” “fixability (beading),” “abrasion resistance,” and “initial filling property” as follows. The results are shown in Table

### Drying Property

The drying properties were evaluated through pressing filter paper against a solid image formed on the printing medium, visually observing the degree of transfer to the filter paper, and assessing based on the criteria below. An evaluation result graded B or above is considered usable in practical applications.

### Evaluation Criteria

A: Transfer of pigment to filter paper little observed
B: Transfer of pigment to filter paper slightly observed
C: Transfer of pigment to cotton cloth clearly observed

### Fixability (Beading)

Uneven printing of the solid image formed on the printing medium was visually observed to evaluate fixability (beading) according to the following evaluation criteria. An evaluation result graded B or above is considered usable in practical applications.

### Evaluation Criteria

A: Excellent (No beading present at all)
B: Good (Beading slightly present)
C: Fair (Beading present)
D: Poor (Beading significantly present)

### Abrasion Resistance

The solid image formed on the printing medium was rubbed 10 times with a cotton cloth, and the degree of pigment transfer to the cloth was visually observed and evaluated based on the criteria below. An evaluation result graded B or above is considered usable in practical applications.

### Evaluation Criteria

A: Pigment was minimally transferred to cotton cloth
B: Pigment was slightly transferred to cotton cloth
C: Transfer of pigment to cotton cloth clearly observed

### Initial Filling Property

An inkjet printer (IPSiO GX-5000, available from Ricoh Co., Ltd.) without ink was filled with the ink mentioned above. Immediately after filling, a nozzle check pattern was printed out using the print setting maintenance function to check nozzle clogging. The initial filling properties were evaluated based on the criteria below. An evaluation result graded B or above is considered usable in practical applications.

### Evaluation Criteria

A: No non-discharging nozzle
B: Number of non-discharging nozzles was 1 to 9
C: Number of non-discharging nozzles was 10 or more

### Discharging Stability

A chart with a solid image of 5 percent of the area of A4-sized paper was created. Next, the created chart was printed on five sets of 200 continuous sheets each on OK Topcoat+ printing media (available from OJI PAPER CO., LTD.), and the discharge irregularity of each nozzle after printing was evaluated. The printing mode used was the ‘Plain Paper-Standard Fast’ mode, modified to ‘No Color Correction,’ set via the printer's installed driver. An evaluation result graded B or above is considered usable in practical applications.

### Evaluation Criteria

A: No disturbed discharging
B: Slight disturbed discharging
C: Nozzles with discharging defects or without discharging were present

TABLE 5

| | | Evaluation result | | | | |
|---|---|---|---|---|---|---|
| | | | | | Initial | Dis- |
| | | Drying | Fix- | Abrasion | Filling | charging |
| | | property | ability | resistance | Property | stability |
| Example | 1 | A | A | A | A | A |
| | 2 | B | A | A | A | A |
| | 3 | A | B | A | A | A |
| | 4 | A | A | A | B | B |
| | 5 | A | A | B | A | A |
| | 6 | A | A | A | A | B |
| | 7 | A | A | B | A | A |
| | 8 | A | B | A | A | A |
| | 9 | A | B | A | A | A |
| | 10 | A | B | B | A | A |
| | 11 | A | A | A | A | A |
| | 12 | A | A | A | A | A |
| | 13 | A | A | A | A | A |
| | 14 | B | B | A | A | A |
| | 15 | B | B | A | A | A |
| | 16 | B | B | A | A | A |
| | 17 | A | A | A | A | B |
| | 18 | A | A | A | A | B |
| | 19 | A | A | A | A | B |
| Comparative | 1 | C | D | B | C | C |
| Example | 2 | B | B | B | C | C |

Example 1 is a preferred embodiment of the present invention, demonstrating excellent drying properties, initial filling properties, and discharge stability, and it is also found to produce images with high abrasion resistance and fixability.

Example 2 is an example that does not contain an alcohol-based solvent with a boiling point of not higher than 180 degrees Celsius, resulting in inferior drying properties compared with Example 1.

Example 3 does not use glycol ether as an alcohol-based solvent, resulting in inferior fixability compared to Example 1.

In Example 4, the alcohol-based solvent with a boiling point of not higher than 250 degrees Celsius makes up less than 50 parts of the total solvent, resulting in inferior initial filling properties and discharge stability compared with Example 1.

In Example 5, the amount of resin added is slightly less, resulting in inferior abrasion resistance compared to Example 1.

In Example 6, the amount of resin added is slightly more, resulting in inferior discharge stability compared with Example 1.

In Example 7, the type of resin is not urethane, resulting in inferior abrasion resistance compared with Example 1.

Example 8 does not contain a solvent with a surface tension of not greater than 30 mN/m, resulting in inferior fixability compared with Example 1.

Examples 9 and 10 do not contain a surfactant with an HLB value of 4 or lower, resulting in inferior fixability and abrasion resistance compared with Example 1.

Examples 11 to 13, in which the amount of glycol ether added as an alcohol-based solvent is optimal, are preferable, because they demonstrate excellent drying properties, initial filling properties, and discharge stability, and they are found to produce images with high abrasion resistance and fixability.

In Examples 14 to 16, the amount of glycol ether added as an alcohol-based solvent is slightly less, resulting in inferior drying properties and fixability compared with Example 1.

In Examples 17 to 19, the amount of glycol ether added as an alcohol-based solvent is slightly more, resulting in inferior discharge stability compared with Example 1.

Comparative Example 1 uses an alcohol-based solvent with a boiling point higher than 250 degrees, resulting in inferior drying properties, discharge stability, initial filling properties, and fixability compared with the Examples.

Comparative Example 2 does not use an alcohol-based solvent, resulting in inferior discharge stability and initial filling properties compared with the Examples.

Judging from the results shown in Table 5, the ink of the present invention is clearly suitable for use in combination with a high-density nozzle head and allows for high-speed printing. Additionally, the inks in Examples 1 to 19 exhibited excellent drying properties, discharge stability, abrasion resistance, fixability, and initial filling properties.

Aspects of the embodiments of the present invention are, for example, as follows:

### Aspect 1

An image forming apparatus includes a nozzle plate having two or more nozzle holes along with a piezoelectric element, and an ink containing a solvent containing an organic solvent containing an alcohol-based organic solvent with a boiling point not higher than 250 degrees Celsius, wherein the average number of the two or more nozzle holes on the surface of the nozzle plate is 10 holes/mm², and the two or more nozzle holes adjacent to each other along a direction substantially perpendicular to the conveyance direction of a recording medium is spaced 150 to 500 μm apart.

### Aspect 2

The image forming apparatus according to Aspect 1 mentioned above, wherein the alcohol-based organic solvent has a boiling point not higher than 180 degrees Celsius.

### Aspect 3

The image forming apparatus according to Aspect 1 or 2 mentioned above, wherein the alcohol-based organic solvent contains a glycol ether.

### Aspect 4

The image forming apparatus according to Aspect 1 or 2 mentioned above, wherein the alcohol-based organic solvent accounts for not lower than 50 percent by mass of the entire of the solvent in the ink.

### Aspect 5

The image forming apparatus according to Aspect 1 or 2 mentioned above, wherein the ink contains a resin with a content of 5 to 10 percent by mass to the entire of the ink.

### Aspect 6

The image forming apparatus according to Aspect 5 mentioned above, wherein the resin contains a urethane resin.

### Aspect 7

The image forming apparatus according to Aspect 1 or 2 mentioned above, wherein the alcohol-based organic solvent has a surface tension of not greater than 30 mN/m at 25 degrees Celsius.

### Aspect 8

The image forming apparatus according to Aspect 1 or 2 mentioned above, wherein the ink contains a surfactant containing a silicone-based surfactant with an HLB value of 4 or less.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An image forming apparatus comprising:
a nozzle plate comprising two or more nozzle holes and a piezoelectric element; and
an ink comprising a solvent comprising an organic solvent comprising an alcohol-based organic solvent with a boiling point not higher than 250 degrees Celsius,
wherein an average number of the two or more nozzle holes on a surface of the nozzle plate is 10 holes/mm², and
the two or more nozzle holes adjacent to each other along a direction substantially perpendicular to a conveyance direction of a recording medium is spaced 150 to 500 μm apart.

2. The image forming apparatus according to claim 1, wherein the alcohol-based organic solvent has a boiling point not higher than 180 degrees Celsius.

3. The image forming apparatus according to claim 1, wherein the alcohol-based organic solvent comprises a glycol ether.

4. The image forming apparatus according to claim 1, wherein the alcohol-based organic solvent accounts for not lower than 50 percent by mass of an entire of the solvent in the ink.

5. The image forming apparatus according to claim 1, wherein the ink comprises a resin with a content of 5 to 10 percent by mass to an entire of the ink.

6. The image forming apparatus according to claim 5, wherein the resin comprises a urethane resin.

7. The image forming apparatus according to claim 1, wherein the alcohol-based organic solvent has a surface tension of not greater than 30 mN/m at 25 degrees Celsius.

8. The image forming apparatus according to claim 1, wherein the ink comprises a surfactant comprising a silicone-based surfactant with an HLB value of 4 or less.
